(19) United States
(12) Patent Application Publication
(10) Pub. No.: US 2021/0304720 A1
(43) Pub. Date: Sep. 30, 2021

(54) Magnetic Pickup Positioning Mechanism for Electric Musical Instruments

(71) Applicant: Justin Richard Bruen, Bellvue, CO (US)

(72) Inventor: Justin Richard Bruen, Bellvue, CO (US)

(21) Appl. No.: 16/834,825

(22) Filed: Mar. 30, 2020

(51) Int. Cl. G10H 3/18

(52) U.S. Cl. CPC G10H 3/183; G10H 2220/461; G10H 3/181

(57) ABSTRACT

The magnetic pickup positioning mechanism for electric musical instruments is mounted beneath the strings between the neck and bridge of an electric musical instrument like the electric guitar or bass. It includes a length of “C” profile track fastened to the guitar and one or more slide-swivel assemblies that twist-lock into, slide and rotate along the track. Magnetic pickups are mounted to the slide-swivel assemblies that allows the player to use their hand to slide and rotate the pickups to various positions and angles between the neck and bridge in order to get a wide variety of tones.

### BACKGROUND OF THE INVENTION

### 1. Field of the Invention

The Magnetic Pickup Positioning Mechanism for Electric Musical Instruments is relevant to the field of electric musical instruments, in particular in expanding the tonal variety of an electric guitar or bass by allowing the player to slide and rotate the pickups to various positions between the neck and the bridge. This range of movements cannot be achieved by the previous art and greatly expands the tonal options of an electric instrument.

### 2. Discussion of the Prior Art

The freedom for the player to be able to slide and rotate multiple pickups to different positions provides tonal options than cannot be achieved by the previous art of sliding mechanisms with only one pickup, sliding pickups that do not rotate, and pickups that rotate but do not slide.

### BRIEF SUMMARY OF THE INVENTION

The Magnetic Pickup Positioning Mechanism for Electric Musical Instruments expands the tones available from an electric instrument, like guitar or bass, by allowing the player to slide and rotate the pickups by hand into various positions between the neck and bridge of the instrument.

A track is mounted onto or into the body of the instrument, underneath the strings, lengthways between the neck and bridge. The track holds and guides the pickup slide assemblies that standard guitar pickup can be mounted to.

The track will accommodate multiple pickups providing the player with tonal switching options like series, parallel, and phased.

### BRIEF DESCRIPTION OF THE SEVERAL VIEWS OF THE DRAWINGS

FIG. 1 is a top view of the invention mounted beneath the strings in a cavity in the body of an electric guitar.

FIG. 2 is a side view of a magnetic pickup mounted to the slider.

FIG. 3 is a perspective view of the “C” profile track.

FIG. 4 is an expanded side view of the slide-swivel assembly.

FIG. 5 is a side view of the slider.

FIG. 6 is a bottom view of the slider in FIG. 5

FIG. 7 is top view of the glide disc.

FIG. 8 is an expanded cross sectional end view of the slide-swivel assembly with the ends rotated parallel with the opening of the track. This is the way the slide-swivel assembly is oriented for insertion into or removal from the track.

FIG. 9 is a cross sectional end view of the slide-swivel assembly inserted into the track.

FIG. 10 is a cross sectional side view of the slide-swivel assembly with ends rotated perpendicular to the track so that the locking tabs extend into the pockets of the track.

### DETAILED DESCRIPTION OF THE PREFERRED EMBODIMENT

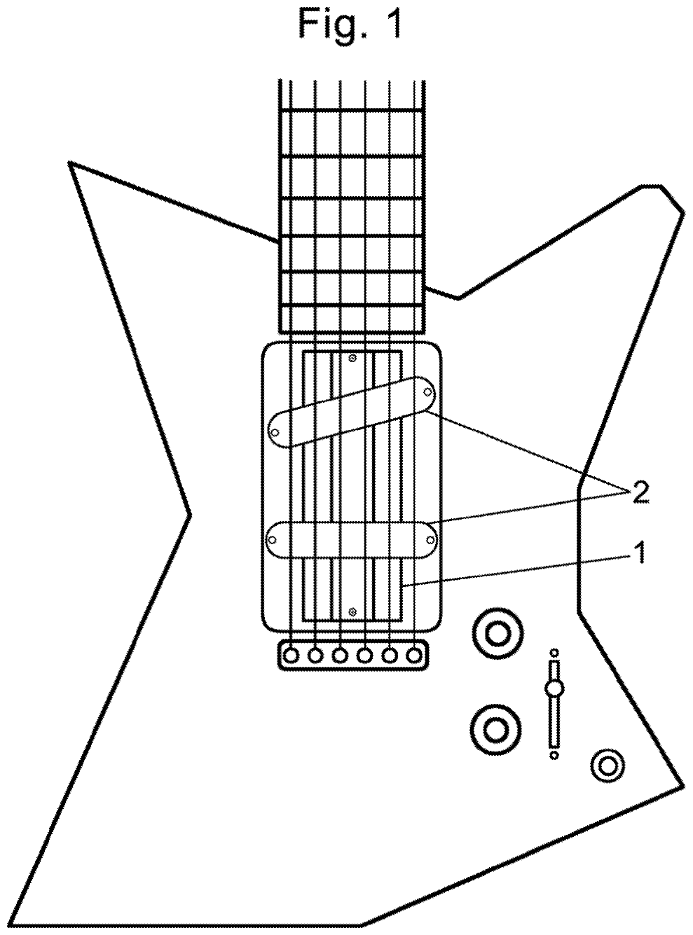

FIG. 1 is a top view of the invention mounted in a cavity in the body of an electric guitar. The track (1) mounts with the opening oriented up and lengthways beneath the strings between neck and bridge, typically in a cavity in the body of the guitar. The opening of the track should be centered beneath the strings so that the pickup will also be centered beneath the strings. The track can be mounted to the body with adhesive, hardware, or any other suitable mean, but mounting hardware should only be placed at the ends of the track so as not to interfere with the movement of the slide-swivel assembly. Two slide-swivel assemblies (2) are shown positioned in different places along the track to illustrate direction of slide along the opening and axis of rotation.

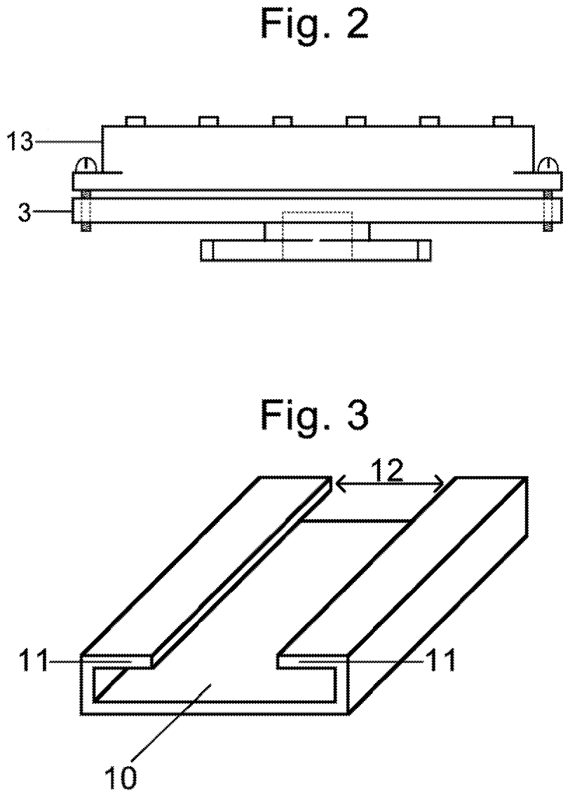

FIG. 2 is a side view of how a magnetic pickup (13) mounts to the slider (3).

FIG. 3 is a perspective view of the “C” profile track. The parts of the track that are referred to later in this description are the floor of the track (10), the returns of the track (11), and the opening of the track (12) which is the open space between the returns of the track.

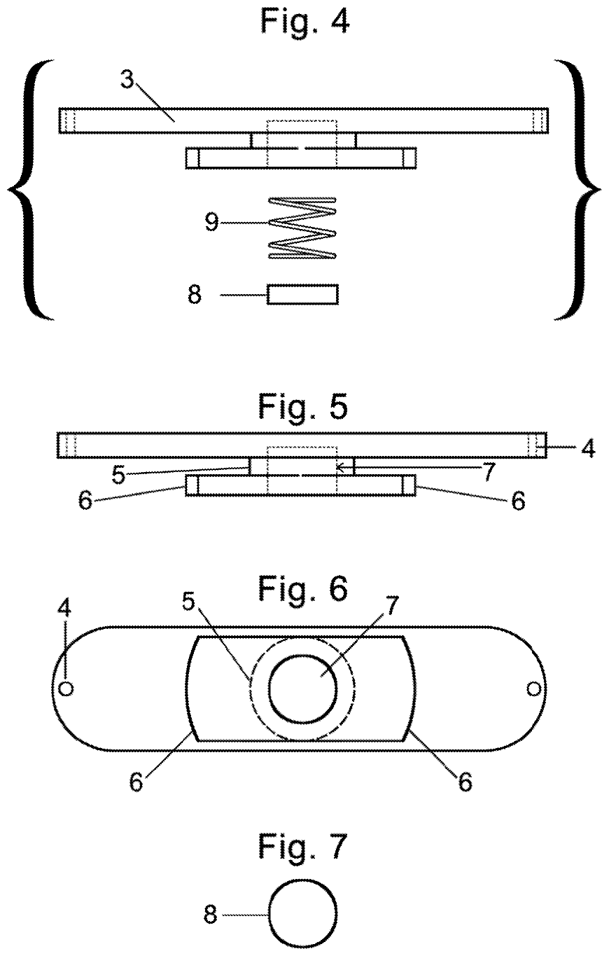

FIG. 4 is an expanded side view of the slide-swivel assembly which includes the slider (3), the spring (9), and the glide disc (8). The spring and glide disc fit into the cavity (7) of the slider when the slider is inserted into the track.

FIG. 5 is a side view of the slider (3) which has three sections, the mounting plate with pickup mounting holes (4), the cylindrical slide-swivel shaft (5), and the locking tabs (6). There is a cavity through the center of the slide-swivel shaft and locking tabs that houses the spring and glide disc. FIG. 6 is a bottom view of the slider in FIG. 5 FIG. 7 is top view of the glide disc (8) which is cylindrical in shape. It has a slightly smaller diameter than the cavity in the slider so that it fits freely into the cavity. The glide keeps the spring from touching the track. Ideally it is made from a low friction or self-lubricating material. It should not be made from a material that will scratch the track when the slide-swivel assembly is moved.

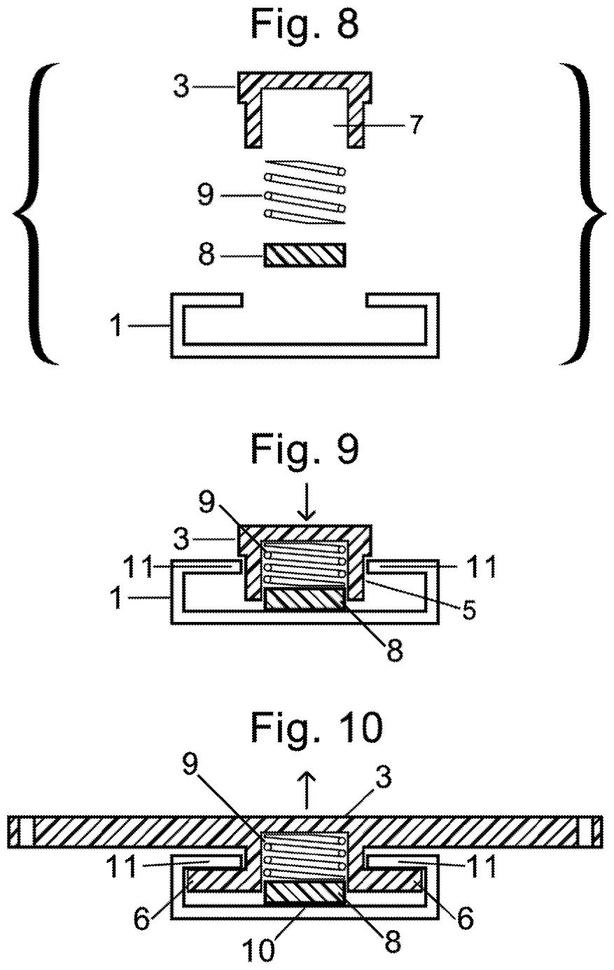

FIG. 8 is an expanded cross sectional end view of the slide-swivel assembly and locking tabs aligned parallel with the opening of the track. This is the way the slide-swivel assembly is oriented for insertion into and removal from the track.

FIG. 9 is a cross sectional end view of the slide-swivel assembly inserted into the track (1). In this orientation the locking tabs of the slider (3) extend lengthways in the same direction as the opening of the track. The width of the locking tabs is equal to the diameter of the slide-swivel shaft (5) and slightly smaller than the opening of the track between the returns (11). This allows the locking tabs to fit down through the opening and into the wider interior of the track. The round slide-swivel shaft (5) occupies the opening of the track and slides and rotates along the opening. The slide-swivel assembly locks into the track when it is rotated away from parallel with the track so that the locking tabs extend beneath the returns of the track (see FIG. 10).

FIG. 10 is a cross sectional side view of the slide-swivel assembly rotated perpendicular to the track (1) so that the locking tabs (6) extend beneath the returns of the track (11). The compressed spring (9) pushes the glide disc (8) down onto the floor of the track (10). In turn, the spring pushes up on the top of the cavity inside slider (3) which causes the locking tabs (6) on the slider (3) to press up against the returns of the track (11) which creates enough friction to keep the slider from moving freely. The ideal spring provides tension small enough that the player can slide and rotate the slide-swivel assembly along the track by hand, but great enough to hold it in place even during most vigorous playing.

1. A musical instrument magnetic pickup positioning mechanism comprising: a length of track with a “C” profile that mounts beneath the strings between the neck and bridge of an electric musical instrument; a slide-swivel assembly on which a magnetic pickup is mounted and twist-locks into the track and slides and rotates along the length of the track when pushed by the players hand.
